(19) United States
(12) Patent Application Publication
(10) Pub. No.: US 2024/0337602 A1
(43) Pub. Date: Oct. 10, 2024

(54) METHOD FOR FINDING BLACK SPOTS IN SEPARATOR

(71) Applicant: SAMSUNG SDI CO., LTD., Yongin-si (KR)

(72) Inventors: Jungyi YU, Yongin-si (KR); Seungwoo LYU, Yongin-si (KR); Changyeon HWANG, Yongin-si (KR); Leehwan AN, Yongin-si (KR)

(21) Appl. No.: 18/381,811

(22) Filed: Oct. 19, 2023

(30) Foreign Application Priority Data
Apr. 10, 2023 (KR) 10-2023-0047091

(51) Int. Cl. G01N 21/88; H01M 10/0525

(52) U.S. Cl. CPC G01N 21/8851; H01M 10/0525; G01N 2021/887; G01N 2021/888

(57) ABSTRACT

A method of finding black spots in a separator according to an embodiment includes taking out a separator from a rechargeable battery cell; removing a foreign material of the separator surface; obtaining a first image for a portion where black spots are estimated in the separator by using a first camera and recording a position of the first image; first selecting the part where black spots are estimated by using the first image, and acquiring a second image for black spots and a foreign material other than black spots in the separator by using a second camera for the recorded position; and secondary selecting black spots by deep learning the first image and the second image with a deep learning software and then displaying the position of the black spots after.

### CROSS-REFERENCE TO RELATED APPLICATION

This application claims priority to and the benefit of Korean Patent Application No. 10-2023-0047091 filed in the Korean Intellectual Property Office on Apr. 10, 2023, the entire contents of which are incorporated herein by reference.

### BACKGROUND

### 1. Field

Embodiments relate to a system for finding black spots in a separator. More particularly, the present disclosure relates to a system for finding black spots of a separator that could cause fine short circuits as dV defects.

### 2. Description of the Related Art

As is known, for a stable cell operation of a rechargeable battery, cells with fine short circuits between a positive electrode and a negative electrode are selected and managed in advance. The cells selected in this way are generally referred to as voltage change (DV, difference) defects, that is, “dV defects”

The dV defects are mainly caused by short-circuits caused by an oxidation of metal foreign materials inside the positive electrode, and a reduction precipitation to the negative electrode and the separator. Conventionally, these short-circuits are called “black spots” because they appear to naked eyes as black dots. Therefore, in order to address the dV defects, it is desirable to find these black spots and figure out which of the metal foreign materials acted to cause the black spots.

The basic method for finding these black spots is to use a human eye. Because the short circuit appears as a black spot on the negative electrode and the separator, a person may observe the negative electrode and the separator with the naked eye and find the black spot.

However, because a visual inspection with the naked eye has a large dispersion among inspectors and may miss small black spots of hundreds of micrometers, even when several cells are dismantled and analyzed, the likelihood of finding the black spots is very low.

### SUMMARY

Embodiments are directed to a system for finding black spots of a separator that automatically selects black spots by using equipment. In addition, embodiments may provide a system for finding black spots of a separator that dramatically improves a discovery ratio of black spots and eliminates a dispersion according to an analyst.

A method of finding black spots in a separator according to an embodiment may include taking out a separator from a rechargeable battery cell; removing a foreign material from the separator surface, obtaining a first image for a portion where black spots are estimated in the separator by using a first camera and recording a position of the first image; first selecting the part where black spots are estimated by using the first image, and acquiring a second image for black spots and a foreign material other than black spots in the separator by using a second camera for the recorded position, and secondarily selecting black spots by deep learning of the first image and the second image with a deep learning software and then displaying the position of the black spots after.

In the taking out of a prismatic case of the rechargeable battery cell, the prismatic case may be disassembled to take out a plurality of electrode assemblies and the amount of a voltage drop may be checked to select one electrode assembly out of the plurality of electrode assemblies, The selected electrode assembly may be unfolded, and one surface of one separator among the unfolded positive electrode, negative electrode, and two separators may be attached to a core of a winding machine and then wound to prepare a sample of the separator.

In the removing of the foreign material, because a first adhesion roller and a first removal roller are sequentially contacted and rotated on the first surface of the separator, the foreign material on the first surface may be removed using the viscosity difference between the first adhesion roller and the first removal roller. When a second adhesion roller and a second removal roller are sequentially contacted and rotated on the second surface of the separator, the foreign material on the second surface may be removed using the viscosity difference between the second adhesion roller and the second removal roller.

Despite the viscosity difference between the first adhesion roller and the first removal roller, and the viscosity difference between the second adhesion roller and the second removal roller, the black spots formed by a metal oxide penetrating the inside of the separator may remain.

In the obtaining of the first image, an area camera may be used as the second camera. The second image may be measured from the separator on a stage drive unit following the roll-to-roll drive unit.

In the acquiring of the second image, the second image may be measured from the separator on a stage drive unit following the roll-to-roll drive unit by using an area camera as the second camera,

In the obtaining of the first image, the first camera may be fixed to measure the first image from the separator in the stopped state of the roll-to-roll drive unit. In the acquiring of the second image, the secondary image may be measured from the moving separator while moving the second camera along with the raised stage driving unit.

In the recording of the position of the first image, a standard marking code may be marked at an equal interval on the separator such that a coordinate may be recognized during the movement of the separator, and the position of the first image may be recorded.

In the recording of the position of the first image, the distance according to the movement time of the separator may be calculated to set a Y coordinate. An X coordinate may be set in the width of the separator within the measurement area of the first camera to record the position of the first image.

In the first selecting, black spots and foreign materials other than black spots may be first selected by using data that can be obtained from the first image. In the second selecting of the black spots, black spots and foreign materials other than the black spots may be secondarily selected by deep learning the first image and the secondary image.

In the first selecting, the first image, including all data obtained from a transmission mode and a reflection mode of the first camera, may be compared.

In the first selecting, by using a gray level of pixels from the first image, the part with a difference between a base and a peak may be detected as the part where black spots are estimated.

In the first selecting, a no good area that differs from the black spots may be first excluded as an OR condition for each data among the data. At this time, a good area that is not excluded may include a first area that can distinguish black spots and foreign materials other than black spots, and a second area that is the same as black spots.

In the first selecting and the acquiring of the second image, an over-detection rate may be reduced by excluding a no good area by using a no good area ratio among the data.

In the first selecting and the acquiring of the second image, a no good area may be excluded using a peak difference of a gray level among the data.

In the first selecting and acquiring of the second image, a no good area may be excluded among the data by using a peak average of a gray level.

In the first selecting and acquiring of the second image, a no good area may be excluded among the data by using a difference of a gray level.

In the first selecting and the acquiring of the second image, a no good area may be excluded among the data by using a difference (an avg gray diff) of an average gray level.

In the first selecting and acquiring of the second image, a no good area may be excluded from among the data by using a difference (a min gray diff) of a minimum gray level.

The method of finding black spots in the separator according to an exemplary embodiment may further include automatically analyzing the components of the black spots by using equipment described herein, The black spots may be identified twice in the first selection and the second selection in the automatic analyzing The components of the black spots may be analyzed with X-rays using X-ray fluorescence analysis (XRF) equipment.

In the method of finding black spots in the separator according to an exemplary embodiment, the first image may be used for the first selection. The secondary image may be obtained at the position where the first image was recorded. The deep learning may be performed for selecting the first image and the second image for the second selection of black spots. Then, the positions of black spots may be displayed, thereby reducing a dispersion of the found black spots among analysts, increasing the ratio of finding the black spots, and improving an inspection speed. In addition, an exemplary embodiment may further analyze components of the black spots through the automatic analysis.

### BRIEF DESCRIPTION OF THE DRAWINGS

Features will become apparent to those of skill in the art by describing in detail exemplary embodiments with reference to the attached drawings in which:

FIG. 1 is a flowchart of a method for finding black spots of a separator according to an embodiment.

FIG. 2 is a schematic diagram of a system for finding black spots of a separator according to an embodiment.

FIG. 3 is a schematic diagram of a foreign material removal unit in FIG. 2.

FIG. 4 is a schematic diagram of a first image measuring unit and a second image measuring unit in FIG. 2.

FIG. 5 is a view showing an optical image of actual black spots in a separator.

FIG. 6 is a view showing a first image obtained by acquiring all data obtained in a transmission mode for a separator.

FIG. 7 is a view showing a first image obtained by acquiring all data obtained from a reflection mode for a separator.

FIG. 8 is a view of a plane image and a cross-section image of a separator showing a method of classifying black spots and foreign materials into gray values as a first image in a separator.

FIG. 9 is a view showing an image that primarily excludes foreign materials other than black spots by utilizing an inappropriate area ratio among data obtained from a first image acquired from a first camera.

FIG. 10 is a view showing an image that primarily excludes foreign materials other than black spots by utilizing a peak change among a data obtained from a first image acquired from a first camera.

FIG. 11 is a view showing an image that primarily excludes foreign materials other than black spots by using a peak average among data obtained from the first image obtained from the first camera.

FIG. 12 is a view showing an image that primarily excludes foreign materials other than black spots by utilizing a gray value change among data obtained from a first image acquired from a first camera.

FIG. 13 is a view showing an image that primarily excludes foreign materials other than black spots by utilizing an average gray value level among data obtained from a first image acquired from a first camera.

FIG. 14 is a view showing an image that primarily excludes foreign materials other than black spots by utilizing a minimum gray value level among a data obtained from a first image acquired from a first camera.

FIG. 15 and FIG. 16 are views showing an image in which black spots are detected as a no good NG by deep learning, a first image, and a second image, and secondary selecting black spots.

FIG. 17 is a view showing an image that detects foreign materials other than black spots as a good OK by secondarily selecting materials other than black spots by deep learning a first image and a second image.

FIG. 18 is a cross-sectional view showing black spots detected in a separator and foreign materials other than black spots excluded from a first selection.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

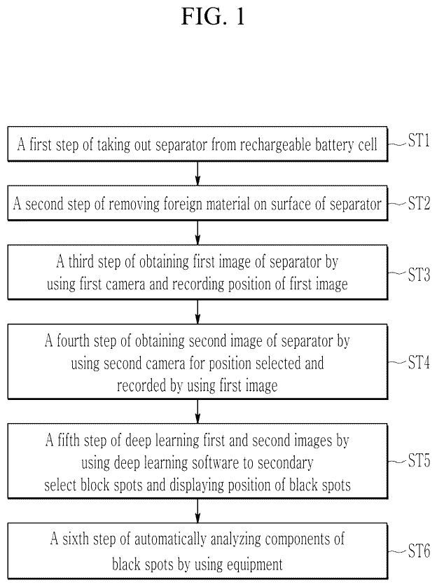

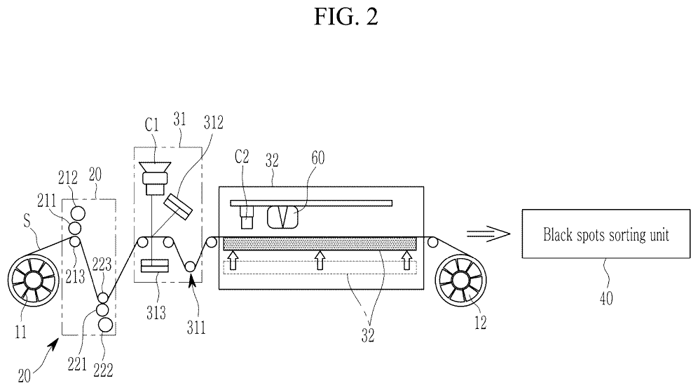

FIG. 1 is a flowchart of a method for finding black spots of a separator according to an embodiment. FIG. 2 is a schematic diagram of a system for finding black spots of a separator according to an embodiment. The method for finding the black spots of the separator and the system used for this method to find the black spots of the separator are explained together with reference to FIG. 1 and FIG. 2.

Referring to FIG. 1 and FIG. 2, the method for finding the black spots of the separator according to an embodiment may further include a first step ST1, a second step ST2, a third step ST3, a fourth step ST4, and a fifth step ST5. The system for finding the block of the separator of an embodiment may include a winding machine 11, a rewinder 12, a foreign material removal unit 20, a first image measuring unit 31, a second image measuring unit 32, and a black spot sorting unit 40.

In the first step ST1, the separator may be taken out from a rechargeable battery cell. The winding machine 11 may be configured to manufacture a sample of the separator S by taking out and winding the separator from the rechargeable battery cell. The winding machine 11 may act as an unwinder to supply the separator S manufactured as a sample from the system. The rewinder 12 may be configured to rewind the separator S passing through the second image measuring unit 32 to be recovered from the system.

In the first step ST1, after disassembling a prismatic case of the rechargeable battery cell and taking out most of the electrode assembly, the amount of a voltage drop may be checked to select one electrode assembly out of multiple electrode assemblies. The selected electrode assembly may be unfolded, and one surface of the separator S of one among the unfolded positive electrode, negative electrode and two separators may be attached to the winding machine 11 core to be wound, thereby preparing the sample of the separator S.

Therefore, the winding machine 11 may be configured to unfold the selected electrode assembly, attach one surface of the separator S of one of the unfolded positive electrode, negative electrode, and two separators to the core of the winding machine 11, and then wind the selected electrode assembly to manufacture the sample of the separator S. A detailed description of the winding machine 11 may be omitted.

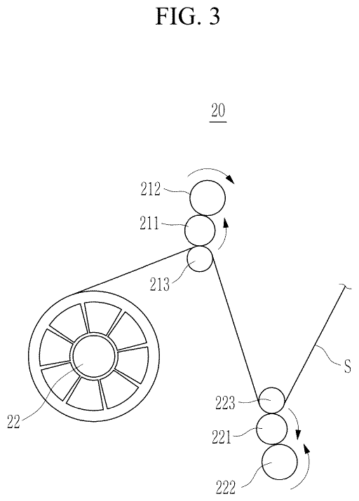

FIG. 3 is a schematic diagram of a foreign material removal unit in FIG. 2. Referring to FIG. 1 to FIG. 3, in the second step ST2, a foreign material on the surface of the separator S may be removed. The foreign material removal unit 20 may be configured to remove foreign material from the surface of the separator S. The foreign material removal unit 20 may include a first adhesion roller 211, a first removal roller 212, a second adhesion roller 221, and a second removal roller 222.

The second step ST2 may include a second/first step. Because the first adhesion roller 211 and the first removal roller 212 are sequentially in contact with the first surface of the separator S and rotated, the foreign material on the first surface may be removed by using a difference in viscosity between the first adhesion roller 211 and the first removal roller 212. In a second/second step in which the second adhesion roller 221 and the second removal roller 222 are sequentially in contact with the second surface of the separator S and rotated, the foreign material on the second surface may be removed by using a viscosity difference between the second adhesion roller 221 and the second removal roller 222.

In the second/first step and the second/second step, despite the difference in the viscosity between the first adhesion roller 211 and the first removal roller 212 and the difference in the viscosity between the second adhesion roller 221 and the second removal roller 222, the black spots formed by a metal oxide penetrating the inside of the separator S may be maintained.

The first adhesion roller 211 and the first removal roller 212 may be in contact and rotated sequentially with the first surface (the upper surface in FIG. 2 and FIG. 3) of the separator S. The first removal roller 212 may be in contact with the first adhesion roller 211 and may be rotated to provide a stronger adhesion force than that of the first adhesion roller 211. That is, by making use of the viscosity difference, the foreign material of the first surface of the separator S supported by the first reaction force roller 213 may be removed.

The second adhesion roller 221 and the second removal roller 222 may be in contact with the second surface (the lower surface in FIG. 2 and FIG. 3) of the separator S and rotated. The second removal roller 222 may be in contact with the second adhesion roller 221 and rotated. The second removal roller may have a stronger adhesion force of that of the second adhesion roller 221. That is, by making use of the viscosity difference, the foreign material on the second surface of the separator S supported by the second reaction force roller 223 may be removed.

The adhesion force may be divided into five steps: weak, medium and weak, medium, medium and strong, and strong. The first and second adhesion rollers 211 and 221 in contact with the first surface and the second surface to remove the foreign materials on the surface of the separator S may proceed as rollers with a medium adhesion. The first and second removal rollers 212 and 222, which transfer and remove the foreign material transferred to the first and second adhesion rollers 211 and 221, may proceed as rollers with a strong adhesion

In order to transfer the foreign material between the first and second adhesion rollers 211 and 221 and the first and second removal roller 212 and 222, there should be a difference of more than 2 steps out of 5 steps in the viscosity. Even in this case, the black spots formed by metal oxide penetrating the inside of the separator S may be maintained in an original state thereof.

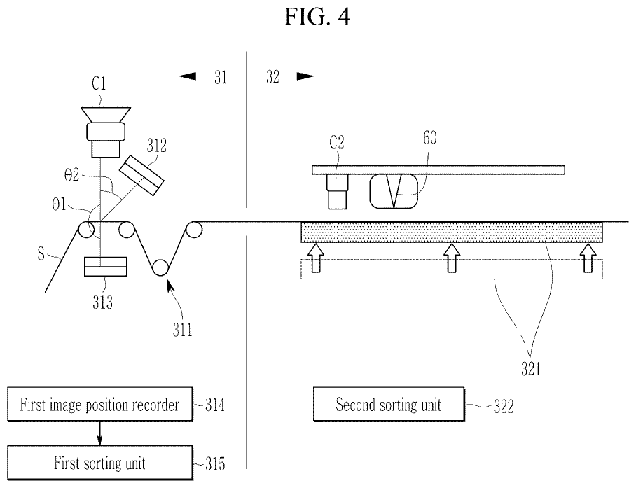

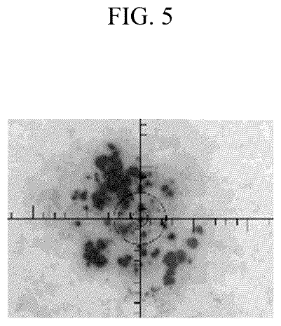

FIG. 4 is a schematic diagram of the first image measuring unit and a second image measuring unit in FIG. 2. Referring to FIG. 1, FIG. 2, and FIG. 4, in the third step ST3, a first image (referring to FIG. 5) for the part where the black spots are estimated in the separator S may be obtained by using a first camera C1, and the position of the first image may be recorded. In the third step ST3, a line camera may be used as the first camera C1 to measure the black and white first image from the separator S on the roll-to-roll driving unit 311.

The first image measuring unit 31 may be configured to obtain the first image for the part where the black spots are estimated in the separator S via the foreign material removal unit 20 by the first camera C1 and the position of the first image may be recorded. The first image measuring unit 31 may include a roll-to-roll driving unit 311 that stops when measuring the first image with the first camera C1 and measures the first image from the separator S.

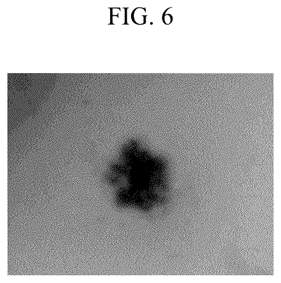

In the fourth step ST4, the part where the black spots are estimated may be first selected by using the first image, and the second image (referring to FIG. 6) for the black spots and the foreign materials other than the black spots in the separator S. By using the second camera C2, the recorded position may be obtained. In the fourth step ST4, an area camera may be used as the second camera C2, and the second image may be measured from the separator S on the stage driving unit 321 following the roll-to-roll driving unit 311.

The second image measuring unit 32 may be configured to first select the location where the black spots are estimated by using the first image of the separator S that has passed through the first image measuring unit 31, and to acquire the second image for the black spots and the foreign material other than the black spots for the recorded position by the second camera C2. The second image measuring unit 32 may follow the roll-to-roll driving unit 311 and may include a stage driving unit 321 that measures the second image from the separator S with the second camera C2.

Again, referring to FIG. 2 and FIG. 4, the first image measuring unit 31 may include a reflected light 312 and a transmission light 313. The reflected light 312 may be placed to reflect the light from the separator S by lighting one surface of the separator S from the first camera C1 side.

The transmission light 313 may be constructed and disposed to light the other surface of the separator S to transmit light through the separator S. The reflected light 312 may be disposed to reach the first camera C1 by a first angle θ1. The transmission light 313 may be disposed to reach the first camera C1 by a second angle θ2. As an non-limiting example, the first angle θ1 may be 180 degrees and the second angle θ2 may be 45 degrees.

The first image measuring unit 31 may further include a first image position recorder 314. The first image position recorder 314 marks a standard marking code on the separator S with an equal interval, recognizes the coordinates during the movement of the separator S, and records the position of the first image.

In addition, the first image position recorder 314 may calculate the distance according to the movement time of the separator S to set the Y coordinate, and sets the X coordinate in the width of the separator S in the measurement area of the first camera C1, thereby recording the position of the first image.

The first image measuring unit 31 may further include a first sorting unit 315 that first sorts the black spots and the foreign materials other than the black spots by using a data obtained from the first image. The second image measuring unit 32 further includes a second sorting unit 322 that secondarily sorts the black spots and the foreign materials other than black spots by deep learning on the first image and the second image.

Referring to FIG. 1, FIG. 2, and FIG. 4, in the third step ST3, the first camera C1 is fixed and the first image may be measured from the separator S in the stopped state of the roll-to-roll driving unit 311. In the fourth step ST4, the second image may be measured from the moving separator S while moving the second camera C2 along with the raised stage driving unit 321. In the fourth step ST4, the first image obtained from all data obtained from the transmission mode and the reflection mode of the first camera C1 may be compared.

In the third step ST3, a standard marking code may be marked on the separator S with an equal interval to recognize a coordinate during the movement of the separator S, and the position of the first image may be recorded in the first image position recorder 314.

Also, in the third step ST3, the Y coordinate may be set by calculating the distance according to the movement time of the separator S. The X coordinate may be set in the width of the separator S within the measurement area of the first camera C1 to record the position of the first image to the first image position recorder 314.

In the fifth step ST5, deep learning may be performed on the first image and the second image with deep learning software to secondarily select the black spots and display the position of the black spots. The black spots sorting unit 40 may be configured to perform deep learning on the first image and on the second image with the deep learning software, secondarily select the black spots, and display the position of black spots.

In the fifth step ST5, the second sorting unit 322 secondary may select the black spots and the foreign materials other than the black spots through the deep learning on the first image and the second image. In the deep learning, the color image of 2.5 μm resolution obtained by the second camera C2 may be learned and selected by black spots BS and other foreign materials FM.

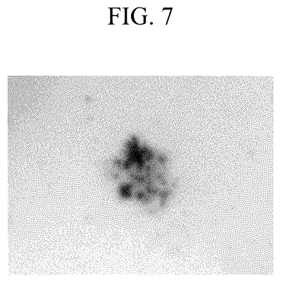

FIG. 5 is a view showing an optical image of actual black spots in a separator. FIG. 6 is a view showing a first image obtained by acquiring all data obtained in a transmission mode for a separator. FIG. 7 is a view showing a first image obtained by acquiring all data obtained from a reflection mode for a separator.

Referring to FIG. 5 to FIG. 7, the data obtained from the transmission mode and the reflection mode may have differences from the actual black spots, and the images of the transmission mode and the reflection mode obtained from the third step ST3 may all be used and compared as the first image.

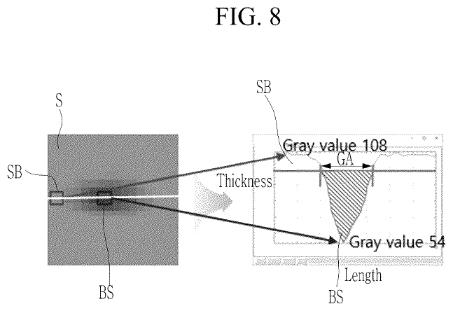

FIG. 8 is a view showing a plane image and a cross-section image of a separator showing a method of classifying black spots and foreign materials into gray values as a first image in a separator. Referring to FIG. 8, in the fourth step ST4, basically, using a gray value (a gray level) of a pixel in the first image, the part with the difference between a base and a peak (peak) is detected as a location where the black spots are estimated. The black spots and the foreign materials may be distinguished using other data.

FIG. 8 is the image of measuring the black spots of 100 μm size of the actual separator S. The pixel 1 of the black spots central portion is 10 μm. The gray value of the base SB of the separator S is 108, and the gray value of the central portion of the black spots BS is 54. The portion with the black spots BS is a good area GA as a detection area.

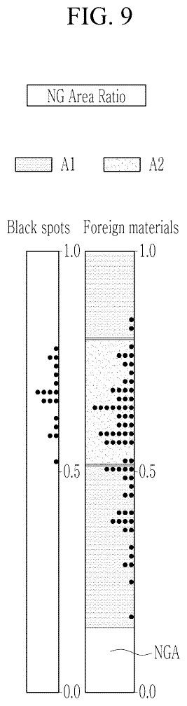

In the fourth step ST4, a no good area NGA that differ from the black spots for each data among the data may be excluded as an OR condition. At this time, the non-excluded good area GA may include a first area A1 capable of distinguishing the black spots BS and foreign materials FM other than the black spots, and a second area A2 that is the same as the black spots (referring to FIG. 9 to FIG. 12).

In each data, the gray values of the no good area NGA and the good area GA, and the first area A1 and the second area A2 of the good area GA are shown in Table 1 and FIG. 9 to FIG. 12

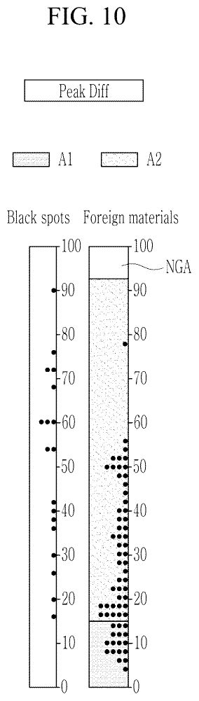

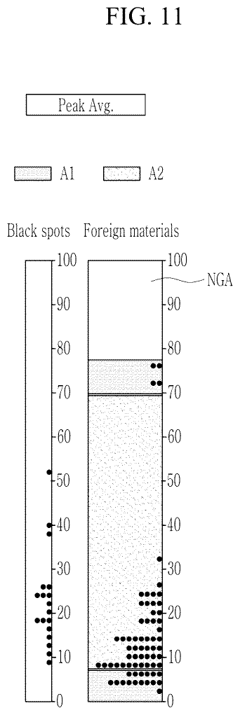

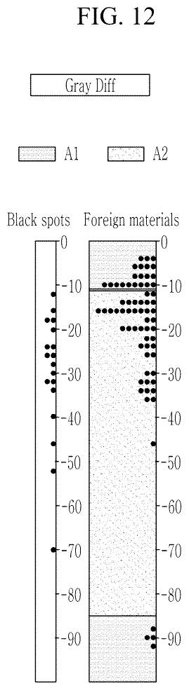

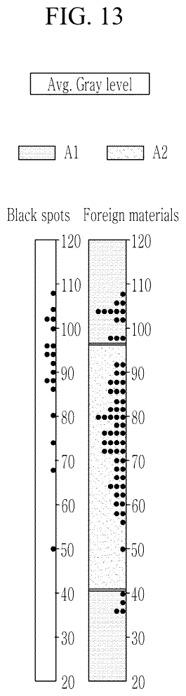

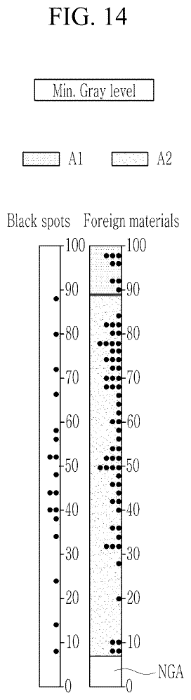

TABLE 1

| Characteristics | Black spots | Foreign material |
|---|---|---|
| No good area ratio (FIG. 9) | 0.51-0.77 | 0.16-0.83 |
| Peak change (FIG. 10) | 15-89 | 4-103 |
| Peak average (FIG. 11) | 7-51 | 2.65-76 |
| Gray value change (FIG. 12) | −13-−70 | −4.5-−92 |
| Average gray value (FIG. 13) | 41-95 | 35-107 |
| Minimum gray value (FIG. 14) | 8-87 | 7-104 |
| Aspect ratio | <1.5 | <10 |

FIG. 9 is a view showing an image that primarily excludes foreign materials other than black spots by utilizing an inappropriate area ratio among a data obtained from a first image acquired from a first camera. Referring to FIG. 9, in the fourth step ST4, the no good area NGA is excluded by using a ratio of the no good area in the data, thereby reducing an over-detection rate in which the foreign materials other than the black spots are excessively detected as the first image. That is, the no good area NGA except the first area A1 and the second area A2 may be excluded, and an exceeding area 0.83 may be excluded from the first area A1.

FIG. 10 is a view showing an image that primarily excludes foreign materials other than black spots by utilizing a peak change among a data obtained from a first image acquired from a first camera. Referring to FIG. 10, in the fourth step ST4, an over-detection rate in which the foreign materials other than the black spots are excessively detected as the first image may be reduced by excluding the no good area NGA by using a peak difference (peak diff) of the gray value (gray level) among the data. That is, the no good area NGA except the first area A1 and the second area A2 may be excluded.

FIG. 11 is a view showing an image that primarily excludes foreign materials other than black spots by using a peak average among data obtained from the first image obtained from the first camera. Referring to FIG. 11, in the fourth step ST4, an over-detection rate in which the foreign materials other than the black spots are excessively detected as the first image, may be reduced by excluding the no good area NGA by using a peak average (peak avg) of the gray value (gray level) among the data. That is, the no good area NGA except the first area A1 and the second area A2 is excluded.

FIG. 12 is a view showing an image that primarily excludes foreign materials other than black spots by utilizing a gray value change among a data obtained from a first image acquired from a first camera. Referring to FIG. 12, in the fourth step ST4, an over-detection rate in which the foreign materials other than the black spots are excessively detected as the first image may be reduced by excluding the no good area NGA by using a difference (diff) of the gray value (gray level) among the data. That is, the no good area NGA except for the first area A1 and the second area A2 may be excluded, and an area exceeding −4.5 and an area less than −92 may be excluded from the first area A1.

FIG. 13 is a view showing an image that primarily excludes foreign materials other than black spots by utilizing an average gray value level among a data obtained from a first image acquired from a first camera. Referring to FIG. 13, in the fourth step ST4, an over-detection rate in which the foreign materials other than the black spots are excessively detected as the first image may be reduced by excluding the no good area NGA by using a difference (avg gray diff) of the average gray value (gray level) among the data. That is, the no good area NGA except for the first area A1 and the second area A2 may be excluded, and an area less than 35 and an area exceeding 107 may be excluded from the first area A1.

FIG. 14 is a view showing an image that primarily excludes foreign materials other than black spots by utilizing a minimum gray value level among a data obtained from a first image acquired from a first camera. Referring to FIG. 14, an over-detection rate in which the foreign materials other than the black spots are excessively detected as the first image may be reduced by excluding the no good area NGA by using a difference (min gray diff) of the minimum gray value (gray level) among the data. That is, the no good area NGA except the first area A1 and the second area A2 may be excluded.

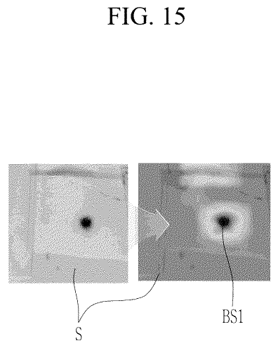

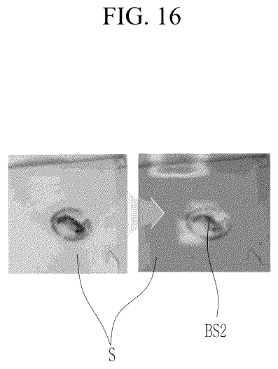

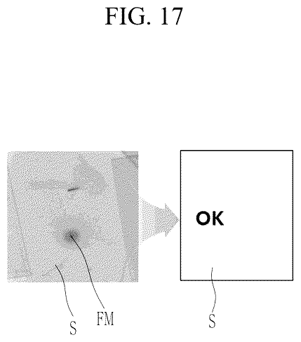

FIG. 15 and FIG. 16 are views showing an image in which black spots are detected as a no good NG by deep learning a first image and a second image and secondary selecting black spots. FIG. 17 is a view showing an image that detects foreign materials other than black spots as a good OK by secondary selecting materials other than black spots by deep learning a first image and a second image.

Referring to FIG. 15 to FIG. 17, in the fifth step ST5, the black spots are secondarily selected to detect the black spots as a no good NG by deep learning the first image and the second image. A material other than the black spots may be secondarily selected, and the foreign material FM other than black spots may be detected as a good OK.

Again, referring to FIG. 1 and FIG. 2, the method for finding the black spots of the separator according to an embodiment may further include a sixth step ST6 of automatically analyzing components of the black spots by using an equipment. The black spots may be characterized twice in the fourth step ST4 and the fifth step ST5 In the sixth step ST6, the components of the black spots may be analyzed with X-rays by using X-ray fluorescence analysis (XRF) equipment.

The system for finding the black spots of the separator of an embodiment may further include a component analysis unit 60 that analyzes the components of the black spots selected in the black spots sorting unit. The component analysis unit 60 may be configured to analyze the components of the black spots with X-rays by using an X-ray Fluorescence Analysis (XRF) facility. The X-ray fluorescence analysis facility may be mounted together on the moving axis of the second camera C2 and may be moved to a specific coordinate to analyze the components of the black spots by using X-rays.

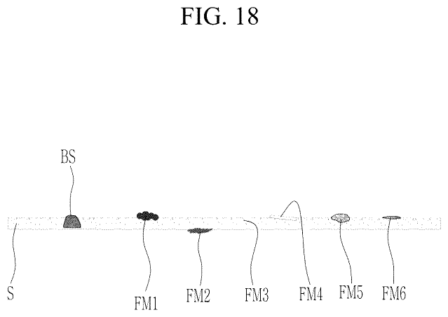

FIG. 18 is a cross-sectional view showing black spots detected in a separator and foreign materials other than black spots excluded from a first selection. FIG. 18 is the result found by the method and system of the embodiment in the sample separator S, which was not found with the naked eye. The black spots BS found with the method and system for finding the black spots of the separator of the embodiment are formed of metal components.

As an example, the metal component may include one of copper, zinc, and stainless steel. The foreign material FM other than the black spots may include one of a positive active material FM1, a negative active material FM2, a stamping FM3, a folding FM4, a separator foreign material FM5, and a side reactant FM6. The Foreign material FM other than the black spots is removed in the foreign material removal unit 20, so an over-detection of the first image is prevented.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of symbols>

| | |
|---|---|
| 11: winding machine | 12: rewinder |
| 20: foreign material removal unit | 31: first image measuring unit |
| 32: secondary image sorting unit | 40: black spots sorting unit |
| 60: component analysis unit | 211: first adhesion roller |
| 212: first removal roller | 221: second adhesion roller |
| 222: second removal roller | 213: first reaction force roller |
| 223: second reaction force roller | 311: roll-to-roll driving unit |
| 312: reflected light | 313: transmission light |
| 314: first image position recorder | 315: first sorting unit |
| 321: stage driving unit | 322: second sorting unit |
| A1: first area | A2: second area |
| BS: black spots | BS1, BS2: black spots |
| C1: first camera | C2: second camera |
| FM: foreign material | FM1: positive active material |
| FM2: negative active material | FM3: stamping |
| FM4: folding | FM5: separator foreign material |
| FM6: side reactant | GA: good area |
| NGA: no good area | S: separator |
| SB: separator base | θ 1: first angle |
| θ 2: second angle | |

What is claimed is:

1. A method of finding black spots in a separator, the method comprising:
taking out the separator from a rechargeable battery cell;
removing a foreign material from a surface of the separator;
obtaining a first image for a portion where black spots are estimated in the separator by using a first camera and recording a position of the first image;
first selecting the portion where the black spots are estimated by using the first image, and acquiring a second image for the black spots and any foreign material other than the black spots in the separator by using a second camera for the recorded position; and
secondary selecting black spots by deep learning the first image and the second image with a deep learning software and then displaying the position of the black spots after.

2. The method of finding black spots in the separator as claimed in claim 1, wherein:
in the taking out,
a prismatic case of the rechargeable battery cell is disassembled to take out a plurality of electrode assemblies and an amount of a voltage drop is checked to select one electrode assembly out of the plurality of electrode assemblies,
the selected electrode assembly is unfolded, and one surface of one separator among the unfolded positive electrode, negative electrode, and two separators is attached to a core of a winding machine and then wound to prepare a sample of the separator.

3. The method of finding black spots in the separator as claimed in claim 1, wherein:
in the removing of the foreign material,
because a first adhesion roller and a first removal roller are sequentially contacted and rotated on the first surface of the separator, the foreign material on the first surface is removed using the viscosity difference between the first adhesion roller and the first removal roller, and
because a second adhesion roller and a second removal roller are sequentially contacted and rotated on the second surface of the separator, the foreign material on the second surface is removed using the viscosity difference between the second adhesion roller and the second removal roller.

4. The method of finding black spots in the separator as claimed in claim 3, wherein:
despite the viscosity difference between the first adhesion roller and the first removal roller, and the viscosity difference between the second adhesion roller and the second removal roller,
the black spots formed by a metal oxide penetrating the inside of the separator remain.

5. The method of finding black spots in the separator as claimed in claim 1, wherein:
in the obtaining of the first image,
the first image is measured from the separator on a roll-to-roll drive unit by using a line camera as the first camera.

6. The method of finding black spots in the separator as claimed in claim 5, wherein:
in the acquiring of the second image,
an area camera is used as the second camera the second image is measured from the separator on a stage drive unit following the roll-to-roll drive unit.

7. The method of finding black spots in the separator as claimed in claim 6, wherein:
in the obtaining of the first image, the first camera is fixed to measure the first image from the separator in a stopped state of the roll-to-roll drive unit, and
in the acquiring of the second image, the secondary image is measured from the moving separator while moving the second camera along with the raised stage driving unit.

8. The method of finding black spots in the separator as claimed in claim 7, wherein:
in the recording of the position of the first image,
a standard marking code is marked with an equal interval on the separator to recognize a coordinate during the movement of the separator and the position of the first image is recorded.

9. The method of finding black spots in the separator as claimed in claim 8, wherein:
in the recording of the position of the first image,
the distance according to the movement time of the separator is calculated to set a Y coordinate, and
an X coordinate is set in the width of the separator within the measurement area of the first camera to record the position of the first image.

10. The method of finding black spots in the separator as claimed in claim 7, wherein:
in the first selecting,
black spots and foreign materials other than black spots are first selected by using a data that can be obtained from the first image, and
in the second selecting of the black spots
black spots and foreign materials other than the black spots are secondary selected by deep learning the first image and the secondary image.

11. The method of finding black spots in the separator as claimed in claim 10, wherein:
in the first selecting,
the first image including all data obtained from a transmission mode and a reflection mode of the first camera is compared.

12. The method of finding black spots in a separator as claimed in claim 10, wherein:
in the first selecting,
the portion with a difference between a base and a peak is detected as the portion where black spots are estimated by using a gray level of pixels from the first image.

13. The method of finding black spots in the separator as claimed in claim 10, wherein:
in the first selecting,
a no good area that differs from the black spots is first excluded as an OR condition for each data among the data,
at this time, a good area that is not excluded includes
a first area that may distinguish black spots and foreign materials other than black spots, and a second area that is the same as black spots.

14. The method of finding black spots in the separator as claimed in claim 13, wherein:
in the first selecting and the acquiring of the second image,
an over-detection rate is reduced by excluding a no good area by using a no good area ratio among the data.

15. The method of finding black spots in the separator as claimed in claim 13, wherein:
in the first selecting and the acquiring of the second image,
a no good area is excluded using a peak difference of a gray level among the data.

16. The method of finding black spots in the separator as claimed in claim 13, wherein:
in the first selecting and the acquiring of the second image,
a no good area is excluded among the data by using a peak average of a gray level.

17. The method of finding black spots in the separator as claimed in claim 13, wherein:
in the first selecting and the acquiring of the second image,
a no good area is excluded among the data by using a difference of a gray level.

18. The method of finding black spots in the separator as claimed in claim 13, wherein:
in the first selecting and the acquiring of the second image,
a no good area is excluded among the data by using a difference (an avg gray diff) of an average gray level.

19. The method of finding black spots in the separator as claimed in claim 13, wherein:
in the first selecting and the acquiring of the second image,
a no good area is excluded among the data by using a difference (a min gray diff) of a minimum gray level.

20. The method of finding black spots in the separator as claimed in claim 10, the method further comprising:
automatically analyzing the components of the black spots by using an equipment,
the black spots are specified twice in the first selection and the second selection,
in the automatically analyzing,
the components of the black spots are analyzed with X-rays using X-ray fluorescence analysis (XRF) equipment.
